(19) United States
(12) Patent Application Publication
(10) Pub. No.: US 2025/0095598 A1
(43) Pub. Date: Mar. 20, 2025

(54) PIXEL DRIVING METHOD, DEVICE THEREOF, AND DISPLAY PANEL THEREOF

(71) Applicant: Shenzhen China Star Optoelectronics Semiconductor Display Technology Co., Ltd., Shenzhen (CN)

(72) Inventor: Bo HAI, Shenzhen (CN)

(21) Appl. No.: 17/773,059

(22) PCT Filed: Apr. 12, 2022
(86) PCT No.: PCT/CN2022/086373

§ 371 Date: Apr. 29, 2022

(30) Foreign Application Priority Data
Mar. 22, 2022 (CN) 202210288558.9

(51) Int. Cl. G09G 3/36

(52) U.S. Cl. CPC G09G 3/3607; G09G 2320/0252; G09G 2320/0257

(57) ABSTRACT

The present application provides a pixel driving method, a device thereof, and a display panel thereof. The method includes: disposing an over-driving voltage value table including sequentially increasing first target grayscale values, second target grayscale values, and third target grayscale values, wherein the first target grayscale values and third target grayscale values has the same over-driving voltage values that corresponding initial grayscale values has; determining the over-driving voltage value corresponding to a grayscale value of a frame to be displayed of a sub-pixel to drive the sub-pixel to emit light.

### FIELD OF INVENTION

The present application relates to a field of display technologies, especially to pixel driving method, a device thereof, and a display panel thereof.

### BACKGROUND OF INVENTION

Liquid crystal displays (LCDs) have advantages such as low power consumption, light weight, high image quality, and low cost, and are extensively applied to electronic appliances such as televisions, digital cameras, and projection devices.

The LCD, by applying a voltage to two ends of a liquid crystal molecule in a sub-pixel, drives the liquid crystal to rotate for a corresponding angle to generate an image through a corresponding amount of light. However, due to limit by a rotation speed of the liquid crystal molecule, a responsive time of the LCD displaying dynamic images is longer such that in a frame time the liquid crystal molecule has no enough rotation angle to allow the sub-pixel to achieve an expected display brightness, which causes an afterimage phenomenon and lowers an image display quality of the LCD.

Therefore, the conventional LCD has the afterimage phenomenon of dynamic images resulting from the lower rotation speed of the liquid crystal molecule, which requires improvement urgently.

### SUMMARY OF INVENTION

### Technical Issue

The embodiment of the present application provides a pixel driving method, a device thereof, and a display panel thereof to solve to solve a technical issue that the slower speed of rotation of the liquid crystal molecule of the conventional LCD resulting in an afterimage phenomenon of dynamic image.

### Technical Solution

An embodiment of the present application provides a pixel driving method, comprising:
disposing an over-driving voltage value table, wherein the over-driving voltage value table comprises a plurality of initial grayscale values and a plurality of target grayscale values corresponding to each other, each of the initial grayscale values and each of the target grayscale values comprises an over-driving voltage value corresponding to the target grayscale value, the target grayscale values comprise first target grayscale values, a plurality of second target grayscale values, and third target grayscale values, each of the second target grayscale values is greater than the first target grayscale values and is less than the third target grayscale values, the first target grayscale values are the same as the over-driving voltage values corresponding to the initial grayscale values different from the first target grayscale values, the third target grayscale values are the same as the over-driving voltage values corresponding to the initial grayscale values different from the third target grayscale values;
obtaining a grayscale value of a frame to be displayed of a sub-pixel, and setting in the over-driving voltage value table the over-driving voltage value corresponding to the target grayscale values the same as the grayscale value of the frame to be displayed as a value of a driving voltage; and
driving the sub-pixel to emit light to display an image of the frame to be displayed according to the driving voltage.

### Advantages

The present application provides a pixel driving method, a device thereof, a display panel thereof, and a storage medium. The pixel driving method comprises: disposing an over-driving voltage value table, wherein the over-driving voltage value table comprises a plurality of initial grayscale values and a plurality of target grayscale values corresponding to each other, each of the initial grayscale values and each of the target grayscale values comprises an over-driving voltage value corresponding to the target grayscale value, the target grayscale values comprise first target grayscale values, a plurality of second target grayscale values, and third target grayscale values, each of the second target grayscale values is greater than the first target grayscale values and is less than the third target grayscale values, the first target grayscale values are the same as the over-driving voltage values corresponding to the initial grayscale values different from the first target grayscale values, the third target grayscale values are the same as the over-driving voltage values corresponding to the initial grayscale values different from the third target grayscale values; obtaining a grayscale value of a frame to be displayed of a sub-pixel, and setting in the over-driving voltage value table the over-driving voltage value corresponding to the target grayscale values the same as the grayscale value of the frame to be displayed as a value of a driving voltage; and driving the sub-pixel to emit light to display an image of the frame to be displayed according to the driving voltage. The present application, by unifying a plurality of over-driving voltage values corresponding to smaller first target grayscale values and unify a plurality of over-driving voltage values corresponding to greater third target grayscale values, can individually fastest drive the liquid crystal molecule to rotate to angles corresponding to both, which further mitigate the afterimage phenomenon and improve an image display quality of the display panel.

### DESCRIPTION OF DRAWINGS

Further descriptions are presented according to the present application as follows. It should be explained that the following accompanying drawings of the descriptions are only some embodiments of the present application, for a person of ordinary skill in the art, can also be used for obtaining other accompanying drawings under a prerequisite without creative efforts.

FIG. 1 is a flowchart of a pixel driving method provided by an embodiment of the present application.

FIG. 2 is a schematic cross-sectional view of a display panel provided by the embodiment of the present application.

FIG. 3 is another flowchart of the pixel driving method provided by the embodiment of the present application.

FIG. 4 is a schematic structural view of a pixel driving device provided by the embodiment of the present application.

FIG. 5 is a schematic structural view of a controller and a memory of the display panel provided by the embodiment of the present application.

### DETAILED DESCRIPTION OF PREFERRED EMBODIMENTS

The technical solution in the embodiment of the present application will be clearly and completely described below with reference to the accompanying drawings in the embodiments of the present application. Apparently, the described embodiments are merely some embodiments of the present application instead of all embodiments. According to the embodiments in the present application, all other embodiments obtained by those skilled in the art without making any creative effort shall fall within the protection scope of the present application.

The terms “first”, “second”, etc. in the description and claims of the present application and the above-mentioned drawings are used to distinguish different objects, not to describe a specific order. In addition, the terms “include” and “have” and any deformation of them is intended to cover non-exclusive inclusion. For, example, a series of processes of steps or modules, method, system, product, or apparatus are included without limits from the listed steps or modules, but it can further optionally comprise a step or a module not listed, or can further optionally comprise other inherent steps or modules of such processes, method, product, or apparatus.

“Embodiment” mentioned in the specification means that a combination of specific features, structures, or characteristics described in the embodiments can be included in at least one embodiment of the present application. The “embodiment” shown in the specification does not exactly mean the same embodiment, an embodiment alternative to other embodiment, or a back-up embodiment. A person of ordinary skill in the art can explicitly or implicitly understand that the embodiments described herein can combine other embodiments.

A main implementation body of the pixel driving method provided by the embodiment of the present application can be a pixel driving device provided by the embodiment of the present application, or be integrated with an electronic apparatus of the pixel driving device. The pixel driving device can be achieved in form of hardware or software.

The embodiment of the present application provides a pixel driving method, a device thereof, a display panel thereof, and a storage medium. Descriptions will be presented respectively as follows.

The embodiment of the present application provides a pixel driving method, each steps of the pixel driving method of the embodiment of the present application would be described in detail as follows.

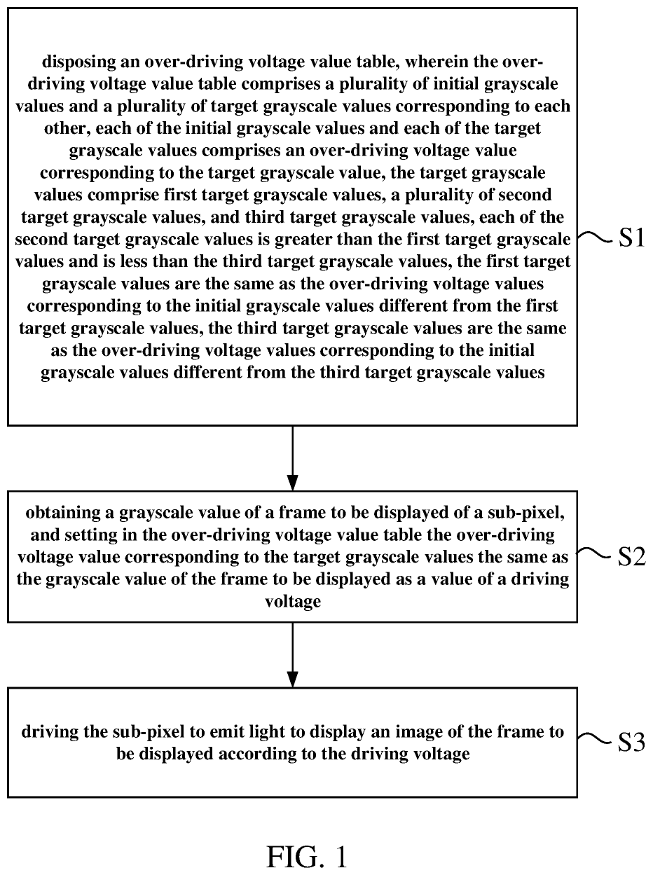

In an embodiment, with reference to FIG. 1, the pixel driving method comprises but is not limited to steps as follows.

A step S1 comprises disposing an over-driving voltage value table, wherein the over-driving voltage value table comprises a plurality of initial grayscale values and a plurality of target grayscale values corresponding to each other, each of the initial grayscale values and each of the target grayscale values comprises an over-driving voltage value corresponding to the target grayscale value, the target grayscale values comprise first target grayscale values, a plurality of second target grayscale values, and third target grayscale values, each of the second target grayscale values is greater than the first target grayscale values and is less than the third target grayscale values, the first target grayscale values are the same as the over-driving voltage values corresponding to the initial grayscale values different from the first target grayscale values, the third target grayscale values are the same as the over-driving voltage values corresponding to the initial grayscale values different from the third target grayscale values.

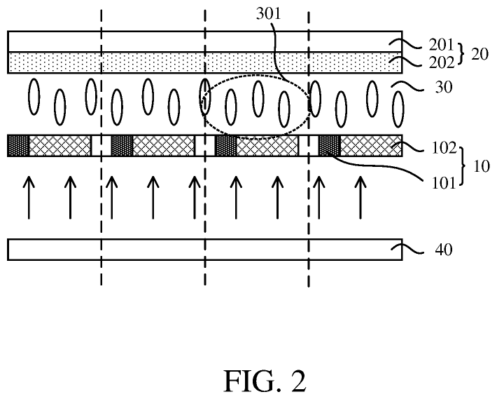

The pixel driving method of the present application can be applied to the display panel. With reference to FIG. 2, the display panel can be a liquid crystal display panel, and the liquid crystal display panel can comprise an array substrate layer 10 and a color filter substrate layer 20 disposed oppositely, a liquid crystal layer 30 disposed between the array substrate layer 10 and the color filter substrate layer 20, and a backlight layer 40 located on a side of the array substrate layer 10 away from color filter substrate layer 20. In particular, array substrate layer 10 comprises a plurality of pixel driving units 101 and a plurality of sub-pixels electrodes 102 arranged in an array and corresponding to each other. Each of the sub-pixel electrodes 102 is electrically connected to a corresponding one of the pixel driving units 101 to be loaded with a corresponding pixel voltage. The color filter substrate layer 20 comprises a color filter layer 201 and a common electrode layer 202 located on a side of the color filter layer 201 near array substrate layer 10 and disposed in form of an entire layer. The common electrode layer 202 is loaded with a common voltage. The liquid crystal layer 30 comprises a plurality of liquid crystal units 301 corresponding to a plurality of the sub-pixel electrodes 102. A plurality of liquid crystal molecules in each of the liquid crystal units 301, under a pixel voltage of a corresponding one of the sub-pixel electrodes 102 and a common voltage of the common electrode layer 202, rotate for a corresponding angle such that light emitted from the backlight layer 40 can pass through the liquid crystal layer 30 in a corresponding amount of light and combine a function of the color filter layer 201 for implementing image display.

In particular, each pixel driving units 101, a corresponding one of the sub-pixel electrodes 102, and a corresponding one of the liquid crystal units 301 can be assembled as a sub-pixel. Because a plurality of sub-pixels have the same common voltage, each sub-pixel can implement different light transmittances under control of a corresponding pixel voltage to present different grayscale values. Namely, each grayscale value of each sub-pixel has a corresponding pixel voltage value. In particular, each pixel voltage value can have a corresponding data voltage value, and when performing image display, can determine a corresponding data voltage value according to a grayscale value required to be presented by each sub-pixel. With reference to FIG. 2, a data voltage of a corresponding data voltage value can be transmitted to the pixel driving unit 101 such that the pixel driving unit 101 applies a pixel voltage of a corresponding pixel voltage value to a corresponding one of the sub-pixel electrodes 102 to drive the liquid crystal molecule in a corresponding one of the liquid crystal units 301 to rotate. The pixel voltage value corresponding to the grayscale value of the sub-pixel can be equal to the data voltage value. It should be noted that a limit of a rotation speed of the liquid crystal molecule results in a longer time for the liquid crystal molecule rotating from the current frame to the frame to be displayed, namely, in a frame, the liquid crystal molecule cannot have an enough rotational angle to cause the corresponding sub-pixel to fail to reach expected display brightness, which presents an afterimage phenomenon and lowers an image display quality of the display panel.

In particular, each of the initial grayscale values in the over-driving voltage value table in the present embodiment can be understood as the grayscale value required to be presented by the sub-pixel in the current frame. Each of the target grayscale values can be understood as the grayscale value required to be presented by the sub-pixel in the frame to be displayed. In the present embodiment, each of the initial grayscale values and each of the target grayscale values have corresponding over-driving voltage values, and the over-driving voltage value here can be understood as a voltage directly or indirectly applied to the sub-pixel electrode 102 corresponding to the sub-pixel such that the liquid crystal molecules in the liquid crystal units 301 rotate to achieve the corresponding sub-pixel switching “from the grayscale value required to be presented by the current frame to the grayscale value required to be presented by the frame to be displayed”.

It can be understood that the driving voltage referring to “data voltage” mentioned in the above descriptions is used as an example for explanation. A plurality of over-driving voltage values of the over-driving voltage value table in the present embodiment can be disposed in combination with a principle of an over driver (OD) technology, namely, an over-driving voltage value of the sub-pixel of the present embodiment corresponding to one of the target grayscale values can be different from a data voltage value corresponding to a grayscale value, equal to target grayscale value, of the sub-pixel required to be presented in a frame to be displayed, and it is required to set a corresponding over-driving voltage value in combination with the initial grayscale value, to mitigate an issue of slower rotation of the liquid crystal molecule. As such, the present embodiment has no limit to specific values of the first target grayscale value and the third target grayscale value, and only needs to fulfill a plurality of second target grayscale values existing between the first target grayscale values and the third target grayscale values, and based on the smaller first target grayscale values, a plurality of over-driving voltage values corresponding to a plurality of initial grayscale values (with removal of those unequal to the first target grayscale values) are set as the same value, and based on the greater third target grayscale values, a plurality of over-driving voltage values corresponding to a plurality of initial grayscale values (with removal of those unequal to the third target grayscale values) are set as another same value.

A step S2 comprises obtaining a grayscale value of a frame to be displayed of a sub-pixel, and setting in the over-driving voltage value table the over-driving voltage value corresponding to the target grayscale values the same as the grayscale value of the frame to be displayed as a value of a driving voltage.

“Grayscale value of the frame to be displayed” in the present step refers to “the grayscale value required to be presented by the display frame” mentioned in the above descriptions. In particular, in combination with the above descriptions, with reference to FIG. 2, in the present embodiment, no matter what initial grayscale values a current frame of the sub-pixel needs to present, when the grayscale value of the frame to be displayed of the sub-pixel is the first target grayscale value, it corresponds to an equal over-driving voltage value, either, when the grayscale value of the frame to be displayed of the sub-pixel is the third target grayscale value, it corresponds to another equal over-driving voltage value. The driving voltage can be understood as “pixel voltage” or “data voltage” mentioned in the above descriptions.

A step S3 comprises driving the sub-pixel to emit light to display an image of the frame to be displayed according to the driving voltage.

In particular, the present embodiment can set an over-driving voltage value table first, then, at least according to a relationship between the grayscale value of the frame to be displayed of the sub-pixel and a plurality of target grayscale values of the over-driving voltage value table, determines and sets an over-driving voltage value as a driving voltage such that a corresponding one of the sub-pixel electrodes 102 is loaded with a corresponding pixel voltage, in combination with the above descriptions, to drive the liquid crystal molecules in the corresponding liquid crystal units 301 to rotate for a corresponding angle to achieve a corresponding amount of penetrating light.

It can be understood that at least based on the first target grayscale values, the second target grayscale values, and the third target grayscale values, the first target grayscale value is a minimum value, for the grayscale value required to be presented by the sub-pixel of the current frame switching from any one of the initial grayscale values (with removal of unequal to the first target grayscale values) to the first target grayscale value, it can be understood that the grayscale value of the sub-pixel moves along a direction of decreasing the value. Furthermore, the present embodiment all sets an equal over-driving voltage value as the value of the driving voltage. The over-driving voltage value corresponding to the first target grayscale value can be understood as the value of the driving voltage most helpful for moving the grayscale value of the sub-pixel along a direction of decreasing the value. Similarly, the third target grayscale values is a maximum value, for the grayscale value required to be presented by the sub-pixel switching from any one of the initial grayscale values (with removal of unequal to the third target grayscale values) required to be presented by the current frame to the third target grayscale value, namely, it can be understood that the grayscale value of the sub-pixel move along a direction of increasing the grayscale value. The present embodiment all sets another equal over-driving voltage value as the value of the driving voltage. The over-driving voltage value corresponding to the third target grayscale value here can be understood as the value of the driving voltage most helpful for moving the grayscale value of the sub-pixel along a direction of increasing the value. Therefore, the present embodiment, by unifying a plurality of over-driving voltage values corresponding to smaller first target grayscale values and unify a plurality of over-driving voltage values corresponding to greater third target grayscale values, can individually fastest drive the liquid crystal molecule to rotate to angles corresponding to both, which further mitigate the afterimage phenomenon and improve an image display quality of the display panel.

In an embodiment, the first target grayscale value is a minimum value of the grayscale value of the sub-pixel, the over-driving voltage value corresponding to the first target grayscale value is the same as the data voltage value corresponding to the grayscale value of the sub-pixel equal to the first target grayscale value. The third target grayscale value is a maximum value of the grayscale value of the sub-pixel, the over-driving voltage value corresponding to the third target grayscale value is the same as the data voltage value corresponding to the grayscale value of the sub-pixel equal to the third target grayscale value.

It can be understood that based on the “the first target grayscale value is a minimum value of the grayscale value of the sub-pixel” and “the third target grayscale value is a maximum value of the grayscale value of the sub-pixel”, it is known that when the grayscale value of the sub-pixel is the first target grayscale value, a corresponding data voltage value can be understood as the minimum value of the data voltage value, namely, it can correspond to a minimum angle of rotation of the liquid crystal molecule. Similarly, when the grayscale value of the sub-pixel is the third target grayscale value, a corresponding data voltage value can be understood as the maximum value of the data voltage value, namely, it can correspond to a maximum angle of rotation of the liquid crystal molecule. In particular, the first target grayscale value being 0, the third target grayscale value being 255 are used as an example for explanation. As shown in table 1, “X” refers to an initial grayscale value, “Y” refers to a target grayscale value. it is known from observation that when Y is equal to 0, over-driving voltage values V_{(51,0)}, V_{(204,0)}, V_{(255,0)} corresponding to X equal to 51, 204 or 255 are equal, and it can be
equal to the data voltage value V′₀ corresponding to the grayscale value of 0. Similarly, when Y is equal to 255, over-driving voltage value V_{(0,255)}, V_{(51,255)}, V_{(204,255)} corresponding to X equal to 0, 51, or 204 are equal, and it can be equal to the data voltage value V′255 corresponding to the grayscale value of 255. It should be noted that when the initial grayscale value “X” is equal to the target grayscale value “Y”, a rotation angle of the liquid crystal molecule needs no changes. In the meantime, the data voltage value only needs to keep the grayscale value equal to initial grayscale values or the data voltage value corresponding to the target grayscale value.

TABLE 1

| over-driving | | X ( initial grayscale values ) | | | |
|---|---|---|---|---|---|
| voltage value | | X = 0 | X = 51 | X = 204 | X = 255 |
| Y | Y = 0 | / | V_{(51,0)} | V_{(204,0)} | V_{(255,0)} |
| | | | (=V′₀) | (=V′₀) | (=V′₀) |
| | Y = 51 | V_{(0,51)} | / | V_{(204,51)} | V_{(255,51)} |
| | | (>V′₅₁) | | (<V′₅₁) | (<V′₅₁) |
| | | | | | (>V_{(204,51)}) |
| | Y = 204 | V_{(0,204)} | V_{(51,204)} | / | V_{(255,204)} |
| | | (>V′₂₀₄) | (>V′₂₀₄) | | (<V′₂₀₄) |
| | | (>V_{(51,204)}) | | | |
| | Y = 255 | V_{(0,255)} | V_{(51,255)} | V_{(51,255)} | / |
| | | (=V′₂₅₅) | (=V′₂₅₅) | (=V′₂₅₅) | |

Therefore, the present embodiment, by unifying a plurality of over-driving voltage values of the first target grayscale values of the minimum value equal to the grayscale value as a minimum value of the data voltage value, namely, using the minimum value of the data voltage value to directly or indirectly drive the liquid crystal molecule to rotate, can fastest drive liquid crystal molecule to rotate to a minimum angle. Similarly, the present embodiment, by unifying a plurality of over-driving voltage values corresponding to the third target grayscale values of the maximum value equal to the grayscale value as a maximum value of the data voltage value, namely, using the maximum value of the data voltage value to directly or indirectly drive liquid crystal molecule to rotate, can fastest drive the liquid crystal molecule to rotate to a maximum angle. Both can further mitigate the afterimage phenomenon to improve the image display quality of the display panel.

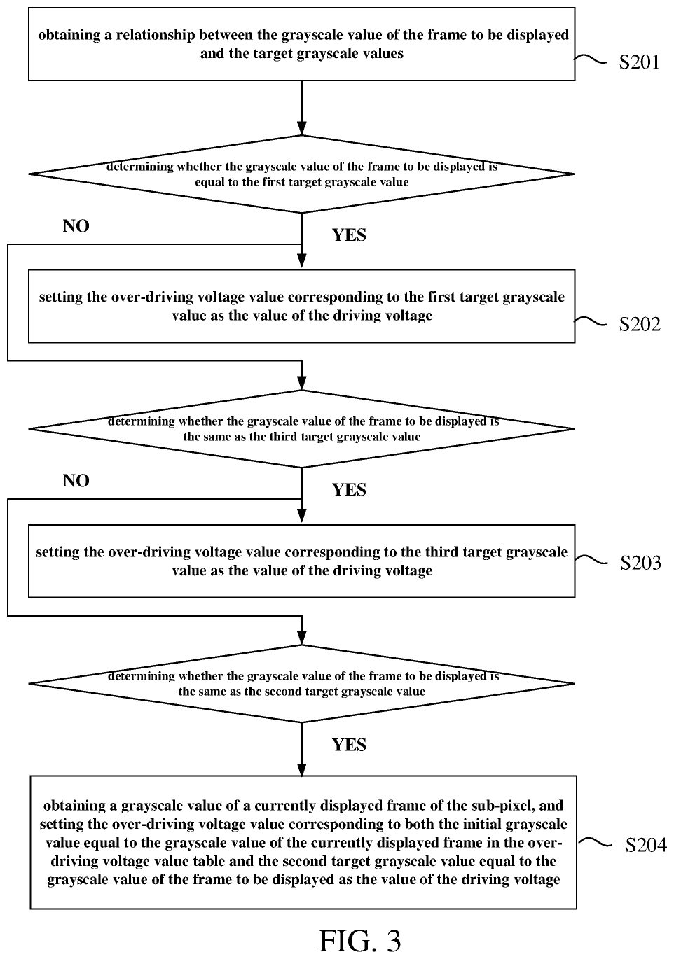

In an embodiment, with reference to FIG. 3, the step S2 can comprise but is not limited to a step as follows.

A step S201 comprises obtaining a relationship between the grayscale value of the frame to be displayed and the target grayscale values.

In particular, in combination with the above descriptions, because the first target grayscale value is the same as over-driving voltage value corresponding to each of the initial grayscale values, the third target grayscale value is the same as over-driving voltage value corresponding to each of the initial grayscale values, namely, the value of the driving voltage in the step S2 and a determining method should first consider a relationship between the grayscale value of the frame to be displayed and the target grayscale values. In particular, it can determine whether the grayscale value of the frame to be displayed is equal to any one of the second target grayscale values or not.

When the grayscale value of the frame to be displayed is equal to the first target grayscale value, a step S202 is implemented, the step S202 comprises setting the over-driving voltage value corresponding to the first target grayscale value as the value of the driving voltage. In particular, in combination with the above descriptions, because the first target grayscale value is the same as the over-driving voltage value corresponding to each of the initial grayscale values. When it is determined that the grayscale value of the frame to be displayed is equal to the first target grayscale value, no matter which the initial grayscale value is, the corresponding value of the driving voltage is the over-driving voltage value corresponding to the first target grayscale value, and further, can be a minimum value of the data voltage value.

When the grayscale value of the frame to be displayed is the same as the third target grayscale value, a step S203 is implemented, the step S203 comprises setting the over-driving voltage value corresponding to the third target grayscale value as the value of the driving voltage. Similarly, because the third target grayscale values is the same as the over-driving voltage value corresponding to each of the initial grayscale values, when it is determined that the grayscale value of the frame to be displayed is the same as the third target grayscale value, no matter what the initial grayscale value is, the corresponding value of the driving voltage is always the over-driving voltage value corresponding to the third target grayscale value, and further, it can be the maximum value of the data voltage value.

When the grayscale value of the frame to be displayed is the same as the second target grayscale values, a step S204 is implemented, the step S204 comprises obtaining a grayscale value of a currently displayed frame of the sub-pixel, and setting the over-driving voltage value corresponding to both the initial grayscale value equal to the grayscale value of the currently displayed frame in the over-driving voltage value table and the second target grayscale value equal to the grayscale value of the frame to be displayed as the value of the driving voltage. In particular, in combination with the above descriptions, each of the initial grayscale values and each of the target grayscale values comprise a corresponding over-driving voltage value, the present embodiment further limits the value of the driving voltage corresponding to the grayscale value of the frame to be displayed equal to the second target grayscale value to not only relate to a relationship between the grayscale value of the frame to be displayed and the target grayscale values, but also relate to a relationship between the grayscale value of the currently displayed frame and the initial grayscale values.

It can be understood that because any one of the second target grayscale values is unequal to a minimum value or maximum value of the target grayscale values, namely, a target grayscale value is greater than or is less than second target grayscale values still exists and results in two existing directions for the grayscale value of the currently displayed frame switch to the grayscale value of the frame to be displayed. Therefore, in the present embodiment, based on the grayscale value of the frame to be displayed the same as the second target grayscale value, considering a relationship between the grayscale value of the currently displayed frame and a plurality of initial grayscale values to determine a switching direction for the grayscale value of the currently displayed frame switching to the grayscale value of the frame to be displayed can raise and improve a precision of the afterimage phenomenon to further improve an image display quality of the display panel.

In an embodiment, the initial grayscale values comprise a first initial grayscale value less than the second target grayscale value. The over-driving voltage values corresponding to the first initial grayscale value and the second target grayscale values are greater than the data voltage value corresponding to the grayscale value of the sub-pixel the same as the second target grayscale values. In a plurality of initial grayscale values, first initial grayscale value is less than second target grayscale values, in combination with the above descriptions, the over-driving voltage values corresponding to the first initial grayscale value and the second target grayscale value can be understood as: the grayscale value required to be presented by the sub-pixel in the current frame is equal to the value of the data voltage, applied to the sub-pixel electrodes 102 corresponding to the sub-pixel, required for the first initial grayscale value switching to a state that the grayscale value required to be presented by the frame to be displayed is equal to second target grayscale values.

It can be understood that in the present embodiment, it is considered that the first initial grayscale value is less than second target grayscale value, namely, the grayscale value required to be presented by the current frame of the sub-pixel is less than the grayscale value required to be presented by the frame to be displayed. In other words, the grayscale value of the sub-pixel changes along a direction of increasing the value. the present embodiment sets the over-driving voltage values corresponding to the first initial grayscale value and the second target grayscale values to be greater than the grayscale value of the data voltage value corresponding to the sub-pixel the same as the second target grayscale values such that the value of the data voltage can be increased to further increase a force applied to the liquid crystal molecule, which is more helpful for the liquid crystal molecule changing from a smaller rotation angle to a greater rotation angle, to faster drive the liquid crystal molecule to rotate to a corresponding angle to further mitigate the afterimage phenomenon and improve an image display quality of the display panel.

In particular, as shown in table 1, for example, when target grayscale value “Y” is equal to second target grayscale values 51, the over-driving voltage value V_{(0,51)} corresponding to the initial grayscale value “X” equal to first initial grayscale value 0 can be greater than the data voltage value V^{′51} corresponding to the grayscale value is equal to 51, namely, it can raise a speed of the liquid crystal molecule rotating to an angle corresponding to the grayscale value equal to 51. Also, for example, when the target grayscale value “Y” is equal to second target grayscale values 204, the over-driving voltage value V_{(0,204)} corresponding to the initial grayscale value “X” equal to first initial grayscale value 0 can be greater than the data voltage value V: 204 corresponding to the grayscale value equal to 204. Similarly, the over-driving voltage value V_{(51,204)} can be greater than data voltage value V: 204, the over-driving voltage value V_{(51,204)} can be greater than data voltage value V: 204, namely, it can raise a speed of the liquid crystal molecule rotating to an angle corresponding to the grayscale value equal to 204.

In an embodiment, the initial grayscale values comprise a third initial grayscale value and a fourth initial grayscale value both less than the second target grayscale values. The third initial grayscale value is less than the fourth initial grayscale value. The over-driving voltage values corresponding to the third initial grayscale value and the second target grayscale values are greater than the over-driving voltage values corresponding to the fourth initial grayscale value and the second target grayscale values. In a plurality of initial grayscale values, both the third initial grayscale value and the fourth initial grayscale value are less than second target grayscale values, in combination with the above descriptions. Based on the grayscale value required to be presented by the frame to be displayed corresponding to the same second target grayscale value, because the third initial grayscale value is less than fourth initial grayscale value, rotation difficulty of the liquid crystal molecule corresponding to the grayscale value required to be presented by the sub-pixel in the current frame equal to third initial grayscale value, is greater than rotation difficulty of the liquid crystal molecule corresponding to the grayscale value required to be presented by the sub-pixel in the current frame equal to fourth initial grayscale value.

It can be understood that in the present embodiment, it is considered that, based on the same second target grayscale value, rotation difficulty of the liquid crystal molecule corresponding to the third initial grayscale value is greater than rotation difficulty of the liquid crystal molecule corresponding to the fourth initial grayscale value, the over-driving voltage values corresponding to the third initial grayscale value and the second target grayscale value are set to be greater than the over-driving voltage values corresponding to the fourth initial grayscale value and the second target grayscale values such that the value of the data voltage corresponding to the third initial grayscale value applied to the liquid crystal molecule is further increased to increase a force applied to the liquid crystal molecule, which is more helpful for the liquid crystal molecule changing from a smaller rotation angle to a greater rotation angle to faster drive the liquid crystal molecule to rotate to a corresponding angle to further mitigate the afterimage phenomenon and improve an image display quality of the display panel. Furthermore, for any one of the same second target grayscale values, reasonably setting the over-driving voltage values corresponding to the third initial grayscale value and the second target grayscale value and the over-driving voltage values corresponding to the fourth initial grayscale value and the second target grayscale values, under a prerequisite of improvement of the rotation speed of the liquid crystal molecule, can achieve the same time for the liquid crystal molecule rotating to a rotation angle corresponding to the second target grayscale value, and can even achieve the same time for the liquid crystal molecule rotating from any one of the initial grayscale values to any one of the target grayscale values.

In particular, as shown in table 1, for example, when the target grayscale value “Y” is equal to the second target grayscale value 204, an over-driving voltage value V_{(0,204)} corresponding to the initial grayscale value “X” equal to the first initial grayscale value 0 can be greater than the over-driving voltage value V_{(51,204)} corresponding to the initial grayscale value “X” equal to first initial grayscale value 51. Namely, a speed of the liquid crystal molecule rotating from the grayscale value equal to 0 to an angle corresponding to the grayscale value equal to 204 can be raised. Furthermore, a speed of the liquid crystal molecule rotating from the grayscale value equal to 0 to an angle corresponding to the grayscale value equal to 204, can be equal to a speed of the liquid crystal molecule rotating from the grayscale value equal to 51 to an angle corresponding to the grayscale value equal to 204.

In an embodiment, the initial grayscale values comprise a second initial grayscale value greater than the second target grayscale values, the over-driving voltage values corresponding to the second initial grayscale value and the second target grayscale value are less than the data voltage value of the grayscale value of the sub-pixel the same as the second target grayscale value. In a plurality of initial grayscale values, the second initial grayscale value is greater than second target grayscale value, in combination with the above descriptions, over-driving voltage value corresponding to the second initial grayscale values and the second target grayscale value can be understood as: the grayscale value required to be presented by the sub-pixel in the current frame is equal to the value of the data voltage, applied to sub-pixel a corresponding one of the sub-pixel electrodes 102, required for the second initial grayscale value switching to a state that the grayscale value required to be presented by the frame to be displayed is equal to second target grayscale values.

It can be understood that in the present embodiment, it is considered that, the second initial grayscale values is greater than second target grayscale values, namely, the grayscale value required to be presented by the current frame of the sub-pixel is greater than the grayscale value required to be presented by the frame to be displayed. In other words, the grayscale value of the sub-pixel changes along a direction of decreasing the value. The present embodiment sets the over-driving voltage values corresponding to the second initial grayscale value and the second target grayscale value to be less than the grayscale value of the data voltage value corresponding to the sub-pixel the same as the second target grayscale values such that the value of the data voltage can be decreased to further decrease a force applied to the liquid crystal molecule to be more helpful for the liquid crystal molecule changing from a greater rotation angle to a smaller rotation angle, to faster drive the liquid crystal molecule to rotate to a corresponding angle to further mitigate the afterimage phenomenon and improve an image display quality of the display panel.

In particular, as shown in table 1, for example, when the target grayscale value “Y” is equal to second target grayscale values 51, the initial grayscale value “X”, equal to an over-driving voltage value V (204,51) corresponding to the first initial grayscale value 204, can be less than a data voltage value V′₅₁ corresponding to the grayscale value equal to 51. Similarly, the over-driving voltage value V_{(255,51)} can be less than data voltage value V′₅₁, namely it can improve a speed of the liquid crystal molecule rotating to an angle corresponding to the grayscale value is equal to 51. Also, for example, when the target grayscale value “Y” is equal to second target grayscale values 204, over-driving voltage value V_{(255,204)} corresponding to the initial grayscale value “X” equal to first initial grayscale value 255 can be less than the data voltage value V′₂₀₄ corresponding to the grayscale value equal to 204, namely, it can improve a speed of the liquid crystal molecule rotating to an angle corresponding to the grayscale value equal to 204.

In an embodiment, the initial grayscale values comprise a fifth initial grayscale value and a sixth initial grayscale value both greater than the second target grayscale values. The fifth initial grayscale value is greater than the sixth initial grayscale value. The over-driving voltage values corresponding to the fifth initial grayscale value and the second target grayscale value are greater than the over-driving voltage values corresponding to the sixth initial grayscale values and the second target grayscale value. In a plurality of initial grayscale values, both the fifth initial grayscale value and the sixth initial grayscale value are greater than second target grayscale value, in combination with the above descriptions, based on the grayscale value required to be presented by the frame to be displayed corresponding to the second target grayscale value, because the fifth initial grayscale value is greater than sixth initial grayscale values, rotation difficulty of the liquid crystal molecule corresponding to the grayscale value required to be presented by the sub-pixel in the current frame equal to fifth initial grayscale values, is greater than rotation difficulty of the liquid crystal molecule corresponding to the grayscale value required to be presented by the sub-pixel in the current frame equal to sixth initial grayscale values.

It can be understood that in the present embodiment, it is considered that, based on the same second target grayscale value, rotation difficulty of the liquid crystal molecule corresponding to the fifth initial grayscale value, is greater than rotation difficulty of the liquid crystal molecule corresponding to the sixth initial grayscale value, the over-driving voltage values corresponding to the fifth initial grayscale value and the second target grayscale value are disposed to be greater than the over-driving voltage values corresponding to the sixth initial grayscale values and the second target grayscale values such that the value of the data voltage applied to the liquid crystal molecule, corresponding to the fifth initial grayscale values, is further increased to further decrease a force applied to the liquid crystal molecule, which is more helpful for the liquid crystal molecule changing from a greater rotation angle to smaller rotation angle, to faster drive the liquid crystal molecule to rotate to a corresponding angle to further mitigate the afterimage phenomenon and improve an image display quality of the display panel. Furthermore, for any one of the same second target grayscale values, reasonably setting the over-driving voltage values corresponding to the fifth initial grayscale value and second target grayscale value and the over-driving voltage values corresponding to the sixth initial grayscale value and the second target grayscale value, under a prerequisite of improvement of the rotation speed of the liquid crystal molecule, can achieve the same time for the liquid crystal molecule rotating to a rotation angle corresponding to the second target grayscale value, and can even achieve the same time for the liquid crystal molecule rotating from any one of the initial grayscale values to any one of the target grayscale values.

In particular, as shown in table 1, for example, when the target grayscale value “Y” is equal to second target grayscale values 51, the over-driving voltage value V_{(255,51)} corresponding to the initial grayscale value “X” equal to the first initial grayscale value 255 can be greater than the over-driving voltage value V_{(204,51)} corresponding to the initial grayscale value “X” equal to the first initial grayscale value 204. Namely, a speed of the liquid crystal molecule rotating from the grayscale value equal to 255 to a speed of an angle corresponding to the grayscale value equal to 51 can be raised. Furthermore, a speed of the liquid crystal molecule rotating from the grayscale value equal to 255 to an angle corresponding to the grayscale value equal to 51, can be equal to a speed of the liquid crystal molecule rotating from the grayscale value equal to 204 to an angle corresponding to the grayscale value equal to 51.

For better embodying the above method, a pixel driving device is provided in an embodiment.

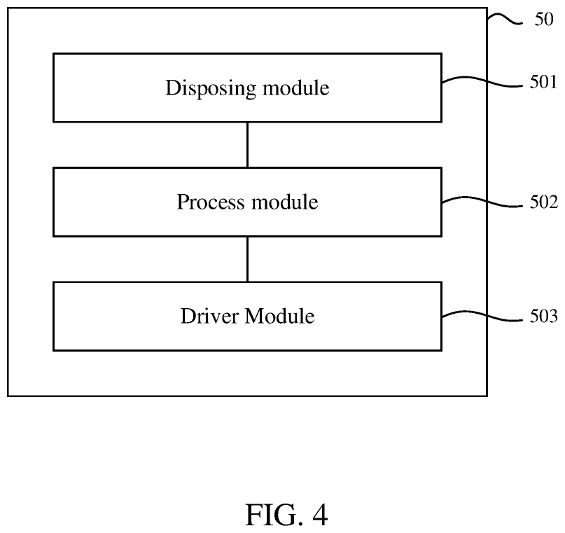

With reference to FIG. 4, FIG. 4 is a schematic structural view of a pixel driving device provided by the embodiment of the present application. The pixel driving device of the present embodiment is described particularly as follows.

In an embodiment, the pixel driving device 50 can comprise but is not limited to modules as follows.

A disposing module 501 is configured to dispose an over-driving voltage value table, wherein the over-driving voltage value table comprises a plurality of initial grayscale values and a plurality of target grayscale values corresponding to each other, each of the initial grayscale values and each of the target grayscale values comprises an over-driving voltage value corresponding to the target grayscale value, the target grayscale values comprise first target grayscale values, a plurality of second target grayscale values, and third target grayscale values, each of the second target grayscale values is greater than the first target grayscale values and is less than the third target grayscale values, the first target grayscale values are the same as the over-driving voltage values corresponding to the initial grayscale values different from the first target grayscale values, the third target grayscale values are the same as the over-driving voltage values corresponding to the initial grayscale values different from the third target grayscale values.

The pixel driving device 50 in the present application can be configured to display panel, with reference to FIG. 2, the display panel can be a liquid crystal display panel, and a specific structure of the display panel can refer to related above descriptions.

In particular, each of the initial grayscale values, each of the target grayscale values, each of the initial grayscale values, each of the target grayscale values in the over-driving voltage value table in the present embodiment have corresponding over-driving voltage values, which can refer to the above related descriptions. The disposing module 501 can be electrically connected to the display panel, and the over-driving voltage value table can be stored in but not limited to the disposing module 501 or display panel.

It can be understood that the driving voltage referring to “data voltage” mentioned in the above descriptions is used as an example for explanation. A plurality of over-driving voltage values of the over-driving voltage value table in the present embodiment can be disposed in combination with a principle of an over driver (OD) technology, namely, an over-driving voltage value of the sub-pixel of the present embodiment corresponding to one of the target grayscale values can be different from a data voltage value corresponding to a grayscale value, equal to target grayscale value, of the sub-pixel required to be presented in a frame to be displayed, and it is required to set a corresponding over-driving voltage value in combination with the initial grayscale value, to mitigate an issue of slower rotation of the liquid crystal molecule. As such, the present embodiment has no limit to specific values of the first target grayscale value and the third target grayscale value, and only needs to fulfill a plurality of second target grayscale values existing between the first target grayscale values and the third target grayscale values, and based on the smaller first target grayscale values, a plurality of over-driving voltage values corresponding to a plurality of initial grayscale values (with removal of those unequal to the first target grayscale values) are set as the same value, and based on the greater third target grayscale values, a plurality of over-driving voltage values corresponding to a plurality of initial grayscale values (with removal of those unequal to the third target grayscale values) are set as another same value.

The process module 502 is configured to obtain a grayscale value of a frame to be displayed of a sub-pixel, and set in the over-driving voltage value table the over-driving voltage value corresponding to the target grayscale values the same as the grayscale value of the frame to be displayed as a value of a driving voltage.

The process module 502 can be electrically connected to the display panel, the grayscale value of the frame to be displayed of the sub-pixel can be but is not limited to be stored in the process module 502 or display panel. “grayscale value of the frame to be displayed” obtained in the process module 502 refers to “the grayscale value required to be presented by the display frame” mentioned in the above descriptions. In particular, in combination with the above descriptions, with reference to FIG. 2, in the present embodiment, no matter what initial grayscale values a current frame of the sub-pixel needs to present, when the grayscale value of the frame to be displayed of the sub-pixel is the first target grayscale value, it corresponds to an equal over-driving voltage value, either, when the grayscale value of the frame to be displayed of the sub-pixel is the third target grayscale value, it corresponds to another equal over-driving voltage value. The driving voltage can be understood as “pixel voltage” or “data voltage” mentioned in the above descriptions.

The driver module 503 is configured to drive the sub-pixel to emit light to display an image of the frame to be displayed according to the driving voltage.

In particular, the over-driving voltage value table can be set in advance in the present embodiment, then the process module 502, at least according to a relationship between the grayscale value of the frame to be displayed of the sub-pixel and the target grayscale values in the over-driving voltage value table, determines and sets a corresponding over-driving voltage value as a driving voltage, then the driver module 503 control a corresponding one of the sub-pixel electrodes 102 to be loaded with a corresponding pixel voltage, in combination with the above descriptions, to drive the liquid crystal molecules in the corresponding liquid crystal units 301 to rotate for a corresponding angle to achieve a corresponding amount of penetrating light.

It can be understood that at least based on the first target grayscale values, the second target grayscale values, and the third target grayscale values, the first target grayscale value is a minimum value, for the grayscale value required to be presented by the sub-pixel of the current frame switching from any one of the initial grayscale values (with removal of unequal to the first target grayscale values) to the first target grayscale value, it can be understood that the grayscale value of the sub-pixel moves along a direction of decreasing the value. Furthermore, the present embodiment all sets an equal over-driving voltage value as the value of the driving voltage. The over-driving voltage value corresponding to the first target grayscale value can be understood as the value of the driving voltage most helpful for moving the grayscale value of the sub-pixel along a direction of decreasing the value. Similarly, the third target grayscale values is a maximum value, for the grayscale value required to be presented by the sub-pixel switching from any one of the initial grayscale values (with removal of unequal to the third target grayscale values) required to be presented by the current frame to the third target grayscale value, namely, it can be understood that the grayscale value of the sub-pixel move along a direction of increasing the grayscale value. The present embodiment all sets another equal over-driving voltage value as the value of the driving voltage. The over-driving voltage value corresponding to the third target grayscale value here can be understood as the value of the driving voltage most helpful for moving the grayscale value of the sub-pixel along a direction of increasing the value. Therefore, the present embodiment, by unifying a plurality of over-driving voltage values corresponding to smaller first target grayscale values and unify a plurality of over-driving voltage values corresponding to greater third target grayscale values, can individually fastest drive the liquid crystal molecule to rotate to angles corresponding to both, which further mitigate the afterimage phenomenon and improve an image display quality of the display panel.

The present application also provides a display panel, the display panel comprises a controller. The controller is configured to implement instructions stored in a memory to implement the pixel driving method as the above descriptions.

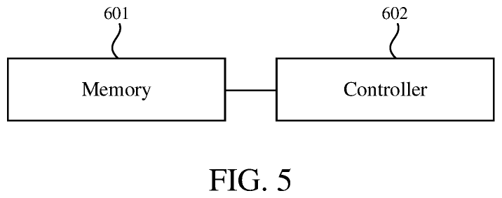

In an embodiment, the display panel further comprises a memory and a storage disk device. With reference to FIG. 5, FIG. 5 is a schematic structural view of a controller and a memory of the display panel provided by the embodiment of the present application.

The memory 601 can be configured to store software program and module, it mainly can comprise a storage program region and a storage data region. A controller 602, by operating the software program and module stored in the memory 601, implements various function applications and data processes. The controller 602, by operating or implementing software programs and modules stored in the memory 601, and calling data stored in the memory 601, implements various functions and process data to perform an entire monitoring.

In some embodiments, the controller 602 disposes an over-driving voltage value table, wherein the over-driving voltage value table comprises a plurality of initial grayscale values and the target grayscale values corresponding to each other, each of the initial grayscale values and each of the target grayscale values comprises an over-driving voltage value corresponding to the target grayscale value, the target grayscale values comprise first target grayscale values, a plurality of second target grayscale values, and third target grayscale values, each of the second target grayscale values is greater than the first target grayscale values and is less than the third target grayscale values, the first target grayscale values are the same as the over-driving voltage values corresponding to the initial grayscale values different from the first target grayscale values, the third target grayscale values are the same as the over-driving voltage values corresponding to the initial grayscale values different from the third target grayscale values.

In some embodiments, the controller 602 obtains a grayscale value of a frame to be displayed of a sub-pixel, and sets the over-driving voltage value table the over-driving voltage value corresponding to the target grayscale values the same as the grayscale value of the frame to be displayed as a value of a driving voltage.

In particular, the controller 602 obtains a relationship between the grayscale value of the frame to be displayed and the target grayscale values. When the grayscale value of the frame to be displayed is the same as the first target grayscale values, the controller 602 sets the over-driving voltage value corresponding to the first target grayscale values as the value of the driving voltage. When the grayscale value of the frame to be displayed is the same as the third target grayscale values, the controller 602 sets the over-driving voltage value corresponding to the third target grayscale values as the value of the driving voltage. When the grayscale value of the frame to be displayed is the same as the second target grayscale values, the controller 602 obtains a grayscale value of a currently displayed frame of the sub-pixel, and sets the over-driving voltage value corresponding to both the initial grayscale value equal to the grayscale value of the currently displayed frame in the over-driving voltage value table and the second target grayscale value equal to the grayscale value of the frame to be displayed as the value of the driving voltage.

In some embodiments, the sub-pixel is driven to emit light to display an image of the frame to be displayed according to the driving voltage.

In an embodiment, the present application provides a storage medium, the storage medium stores several instructions, the instructions are configured to allow the controller to implement the instructions to achieve any one of the pixel driving methods as above. It should be explained that a person of ordinary skill in the art can understand that all or some of the step of various methods of the above embodiment can be completed by the program instructing related hardware. The program can be stored in a computer read-only storage medium, for example, be stored in a memory of the electronic apparatus, and be implemented by at least one processor in the electronic apparatus. During implementation, it can comprise a process of an embodiment of a charging notification method. The storage medium can comprise: read only memory (ROM), random access memory (RAM), hard disk or CD-ROM.

The present application provides a pixel driving method, a device thereof, a display panel thereof, and a storage medium thereof, and the pixel driving method comprises: disposing an over-driving voltage value table, wherein the over-driving voltage value table comprises a plurality of initial grayscale values and the target grayscale values corresponding to each other, each of the initial grayscale values and each of the target grayscale values comprises an over-driving voltage value corresponding to the target grayscale value, the target grayscale values comprise first target grayscale values, a plurality of second target grayscale values, and third target grayscale values, each of the second target grayscale values is greater than the first target grayscale values and is less than the third target grayscale values, the first target grayscale values are the same as the over-driving voltage values corresponding to the initial grayscale values different from the first target grayscale values, the third target grayscale values are the same as the over-driving voltage values corresponding to the initial grayscale values different from the third target grayscale values; obtaining a grayscale value of a frame to be displayed of a sub-pixel, and setting in the over-driving voltage value table the over-driving voltage value corresponding to the target grayscale values the same as the grayscale value of the frame to be displayed as a value of a driving voltage; and driving the sub-pixel to emit light to display an image of the frame to be displayed according to the driving voltage. The present application, by unifying a plurality of over-driving voltage values corresponding to smaller first target grayscale values and unify a plurality of over-driving voltage values corresponding to greater third target grayscale values, can individually fastest drive the liquid crystal molecule to rotate to angles corresponding to both, which further mitigate the afterimage phenomenon and improve an image display quality of the display panel.

The pixel driving method, the device thereof, the display panel thereof, and the storage medium thereof provided by the embodiment of the present application are described in detail as above. Each function module thereof can be integrated in a process chip, and either can exist physically individually. Also, two or more modules can be integrated in one module. The above integrated module can be implemented in form of a hardware or in form of a software function module. In the specification, the specific examples are used to explain the principle and embodiment of the present application. The above description of the embodiments is only used to help understand the method of the present application and its spiritual idea. Meanwhile, for those skilled in the art, according to the present idea of invention, changes will be made in specific embodiment and application. In summary, the contents of this specification should not be construed as limiting the present application.

1. A pixel driving method, comprising:
disposing an over-driving voltage value table, wherein the over-driving voltage value table comprises a plurality of initial grayscale values and a plurality of target grayscale values corresponding to each other, each of the initial grayscale values and each of the target grayscale values comprises an over-driving voltage value corresponding to the target grayscale value, the target grayscale values comprise first target grayscale values, a plurality of second target grayscale values, and third target grayscale values, each of the second target grayscale values is greater than the first target grayscale values and is less than the third target grayscale values, the first target grayscale values are the same as the over-driving voltage values corresponding to the initial grayscale values different from the first target grayscale values, the third target grayscale values are the same as the over-driving voltage values corresponding to the initial grayscale values different from the third target grayscale values;
obtaining a grayscale value of a frame to be displayed of a sub-pixel, and setting in the over-driving voltage value table the over-driving voltage value corresponding to the target grayscale values the same as the grayscale value of the frame to be displayed as a value of a driving voltage; and
driving the sub-pixel to emit light to display an image of the frame to be displayed according to the driving voltage;
wherein each grayscale value of the sub-pixel comprises a corresponding data voltage value;
wherein the first target grayscale value is a minimum value of the grayscale value of the sub-pixel, the over-driving voltage value corresponding to the first target grayscale value is the same as the data voltage value corresponding to the grayscale value of the sub-pixel the same as the first target grayscale value, the third target grayscale value is a maximum value of the grayscale value of the sub-pixel, and the over-driving voltage value corresponding to the third target grayscale value is the same as the data voltage value corresponding to the grayscale value of the sub-pixel the same as the third target grayscale value;
wherein the initial grayscale values comprise a first initial grayscale value less than the second target grayscale value, the first initial grayscale value and the over-driving voltage value corresponding to the second target grayscale value are greater than the data voltage value corresponding to the grayscale value of the sub-pixel the same as the second target grayscale value.

2. The pixel driving method according to claim 1, wherein the step of setting in the over-driving voltage value table the over-driving voltage value corresponding to the target grayscale values the same as the grayscale value of the frame to be displayed as a value of a driving voltage, comprises:
obtaining a relationship between the grayscale value of the frame to be displayed and the target grayscale values;
when the grayscale value of the frame to be displayed is equal to the first target grayscale value, setting the over-driving voltage value corresponding to the first target grayscale value as the value of the driving voltage;
when the grayscale value of the frame to be displayed is equal to the third target grayscale value, setting the over-driving voltage value corresponding to the third target grayscale value as the value of the driving voltage; and
when the grayscale value of the frame to be displayed is equal to the second target grayscale value, obtaining a grayscale value of a currently displayed frame of the sub-pixel, and setting the over-driving voltage value corresponding to both the initial grayscale value equal to the grayscale value of the currently displayed frame in the over-driving voltage value table and the second target grayscale value equal to the grayscale value of the frame to be displayed as the value of the driving voltage.

3. The pixel driving method according to claim 1, wherein the initial grayscale values comprise a third initial grayscale value and a fourth initial grayscale value both less than the second target grayscale values, and the third initial grayscale value is less than the fourth initial grayscale value; and
wherein the over-driving voltage values corresponding to the third initial grayscale value and the second target grayscale values are greater than the over-driving voltage values corresponding to the fourth initial grayscale value and the second target grayscale values.

4. The pixel driving method according to claim 1, wherein each grayscale value of the sub-pixel comprises a corresponding data voltage value; and
wherein the initial grayscale values comprise a second initial grayscale value greater than the second target grayscale value, and the over-driving voltage value corresponding to the second initial grayscale value and the second target grayscale values is less than the data voltage value corresponding to the grayscale value of the sub-pixel the same as the second target grayscale value.

5. The pixel driving method according to claim 1, wherein the initial grayscale values comprise a fifth initial grayscale value and a sixth initial grayscale value both greater than the second target grayscale value, and the fifth initial grayscale value is greater than the sixth initial grayscale value; and
wherein the over-driving voltage values corresponding to the fifth initial grayscale value and the second target grayscale value are greater than the over-driving voltage values corresponding to the sixth initial grayscale value and the second target grayscale value.

6. A pixel driving method, comprising:
disposing an over-driving voltage value table, wherein the over-driving voltage value table comprises a plurality of initial grayscale values and a plurality of target grayscale values corresponding to each other, each of the initial grayscale values and each of the target grayscale values comprises an over-driving voltage value corresponding to the target grayscale value, the target grayscale values comprise first target grayscale values, a plurality of second target grayscale values, and third target grayscale values, each of the second target grayscale values is greater than the first target grayscale values and is less than the third target grayscale values, the first target grayscale values are the same as the over-driving voltage values corresponding to the initial grayscale values different from the first target grayscale values, the third target grayscale values are the same as the over-driving voltage values corresponding to the initial grayscale values different from the third target grayscale values;
obtaining a grayscale value of a frame to be displayed of a sub-pixel, and setting in the over-driving voltage value table the over-driving voltage value corresponding to the target grayscale values the same as the grayscale value of the frame to be displayed as a value of a driving voltage; and
driving the sub-pixel to emit light to display an image of the frame to be displayed according to the driving voltage.

7. The pixel driving method according to claim 6, wherein the step of setting in the over-driving voltage value table the over-driving voltage value corresponding to the target grayscale values the same as the grayscale value of the frame to be displayed as a value of a driving voltage, comprises:
obtaining a relationship between the grayscale value of the frame to be displayed and the target grayscale values;
when the grayscale value of the frame to be displayed is equal to the first target grayscale value, setting the over-driving voltage value corresponding to the first target grayscale value as the value of the driving voltage;
when the grayscale value of the frame to be displayed is equal to the third target grayscale value, setting the over-driving voltage value corresponding to the third target grayscale value as the value of the driving voltage; and
when the grayscale value of the frame to be displayed is equal to the second target grayscale value, obtaining a grayscale value of a currently displayed frame of the sub-pixel, and setting the over-driving voltage value corresponding to both the initial grayscale value equal to the grayscale value of the currently displayed frame in the over-driving voltage value table and the second target grayscale value equal to the grayscale value of the frame to be displayed as the value of the driving voltage.

8. The pixel driving method according to claim 6, wherein each grayscale value of the sub-pixel comprises a corresponding data voltage value; and
wherein the first target grayscale value is a minimum value of the grayscale value of the sub-pixel, the over-driving voltage value corresponding to the first target grayscale value is the same as the data voltage value corresponding to the grayscale value of the sub-pixel the same as the first target grayscale value; and
the third target grayscale value is a maximum value of the grayscale value of the sub-pixel, and the over-driving voltage value corresponding to the third target grayscale value is the same as the data voltage value corresponding to the grayscale value of the sub-pixel the same as the third target grayscale value.

9. The pixel driving method according to claim 6, wherein each grayscale value of the sub-pixel comprises a corresponding data voltage value; and
wherein the initial grayscale values comprise a first initial grayscale value less than the second target grayscale value, the first initial grayscale value and the over-driving voltage value corresponding to the second target grayscale value are greater than the data voltage value corresponding to the grayscale value of the sub-pixel the same as the second target grayscale value.

10. The pixel driving method according to claim 6, wherein the initial grayscale values comprise a third initial grayscale value and a fourth initial grayscale value both less than the second target grayscale values, and the third initial grayscale value is less than the fourth initial grayscale value; and
wherein the over-driving voltage values corresponding to the third initial grayscale value and the second target grayscale values are greater than the over-driving voltage values corresponding to the fourth initial grayscale value and the second target grayscale values.

11. The pixel driving method according to claim 6, wherein each grayscale value of the sub-pixel comprises a corresponding data voltage value; and
wherein the initial grayscale values comprise a second initial grayscale value greater than the second target grayscale value, and the over-driving voltage value corresponding to the second initial grayscale value and the second target grayscale values is less than the data voltage value corresponding to the grayscale value of the sub-pixel the same as the second target grayscale value.

12. The pixel driving method according to claim 6, wherein the initial grayscale values comprise a fifth initial grayscale value and a sixth initial grayscale value both greater than the second target grayscale value, and the fifth initial grayscale value is greater than the sixth initial grayscale value; and
wherein the over-driving voltage values corresponding to the fifth initial grayscale value and the second target grayscale value are greater than the over-driving voltage values corresponding to the sixth initial grayscale value and the second target grayscale value.

13-14. (canceled)

15. A display panel, wherein the display panel comprises a controller and a memory, wherein the controller is configured to implement instructions stored in the memory to implement the method according to claim 6.

16. The display panel according to claim 15, wherein the step of setting in the over-driving voltage value table the over-driving voltage value corresponding to the target grayscale values the same as the grayscale value of the frame to be displayed as a value of a driving voltage, comprises:
obtaining a relationship between the grayscale value of the frame to be displayed and the target grayscale values;
when the grayscale value of the frame to be displayed is equal to the first target grayscale value, setting the over-driving voltage value corresponding to the first target grayscale value as the value of the driving voltage;
when the grayscale value of the frame to be displayed is equal to the third target grayscale value, setting the over-driving voltage value corresponding to the third target grayscale value as the value of the driving voltage; and
when the grayscale value of the frame to be displayed is equal to the second target grayscale value, obtaining a grayscale value of a currently displayed frame of the sub-pixel, and setting the over-driving voltage value corresponding to both the initial grayscale value equal to the grayscale value of the currently displayed frame in the over-driving voltage value table and the second target grayscale value equal to the grayscale value of the frame to be displayed as the value of the driving voltage.

17. The display panel according to claim 15, wherein each grayscale value of the sub-pixel comprises a corresponding data voltage value; and
wherein the first target grayscale value is a minimum value of the grayscale value of the sub-pixel, the over-driving voltage value corresponding to the first target grayscale value is the same as the data voltage value corresponding to the grayscale value of the sub-pixel the same as the first target grayscale value; and
the third target grayscale value is a maximum value of the grayscale value of the sub-pixel, and the over-driving voltage value corresponding to the third target grayscale value is the same as the data voltage value corresponding to the grayscale value of the sub-pixel the same as the third target grayscale value.

18. The display panel according to claim 15, wherein each grayscale value of the sub-pixel comprises a corresponding data voltage value; and
wherein the initial grayscale values comprise a first initial grayscale value less than the second target grayscale value, the first initial grayscale value and the over-driving voltage value corresponding to the second target grayscale value are greater than the data voltage value corresponding to the grayscale value of the sub-pixel the same as the second target grayscale value.

19. The display panel according to claim 15, wherein the initial grayscale values comprise a third initial grayscale value and a fourth initial grayscale value both less than the second target grayscale values, and the third initial grayscale value is less than the fourth initial grayscale value; and
wherein the over-driving voltage values corresponding to the third initial grayscale value and the second target grayscale values are greater than the over-driving voltage values corresponding to the fourth initial grayscale value and the second target grayscale values.

20. The display panel according to claim 15, wherein each grayscale value of the sub-pixel comprises a corresponding data voltage value; and
wherein the initial grayscale values comprise a second initial grayscale value greater than the second target grayscale value, and the over-driving voltage value corresponding to the second initial grayscale value and the second target grayscale values is less than the data voltage value corresponding to the grayscale value of the sub-pixel the same as the second target grayscale value.
